(19) United States
(12) Patent Application Publication
(10) Pub. No.: US 2009/0147007 A1
(43) Pub. Date: Jun. 11, 2009

(54) PROCESSOR-ASSISTED 2D GRAPHICS RENDERING LOGIC

(76) Inventors: Efim Gukovsky, Stoneham, MA (US); Landis Rogers, Kingston, NH (US); TImothy Hellman, Concord, MA (US); Adam Benton, Cambridge, MA (US); Radhaselvi Venkatesan, Acton, MA (US)

Correspondence Address: MCANDREWS HELD & MALLOY, LTD, 500 WEST MADISON STREET, SUITE 3400, CHICAGO, IL, 60661, US

(21) Appl. No.: 11/966,437

(22) Filed: Dec. 11, 2007

(51) Int. Cl. G06T 11/20

(52) U.S. Cl. 345/443

(57) ABSTRACT

Presented herein is processor assisted two dimensional shape rendering logic. In one embodiment, there is presented a system for rendering graphics. The system comprises a controller and logic. The controller decomposes graphics objects into primitives. The logic determines pixel locations for said graphics objects, using said primitives.

### RELATED APPLICATIONS

This patent application is related to Provisional Patent Application Ser. No. 60/874,565, entitled “Processor-Assisted 2D Graphics Rendering Logic” filed Dec. 12, 2006.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Generally, graphic hardware accelerators take a large amount of chip area, because the entire rendering process is embedded in hardware. Alternately, software-only implementations are generally not fast enough for good interactive response.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

The present invention is directed to a processor-assisted 2D graphics rendering logic as shown in and/or described in connection with at least one of the figures, as set forth more completely in the claims.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 is a block diagram describing an exemplary system for rendering graphics in accordance with an embodiment of the present invention;

FIG. 2 is a block diagram describing a trapezoid rendered in accordance with an embodiment of the present invention;

FIG. 3 is a block diagram describing an exemplary logic block in accordance with an embodiment of the present invention;

FIG. 4 is a block describing the operation of a pipeline in accordance with an embodiment of the present invention;

FIG. 5 is a block diagram describing a host interference in accordance with an embodiment of the present invention;

FIG. 6 is a block diagram describing an end point generator in accordance with an embodiment of the present invention; and

FIG. 7 is a block diagram describing an exemplary Bresenham engine in accordance with an embodiment of the present invention.

### DETAILED DESCRIPTION OF THE INVENTION

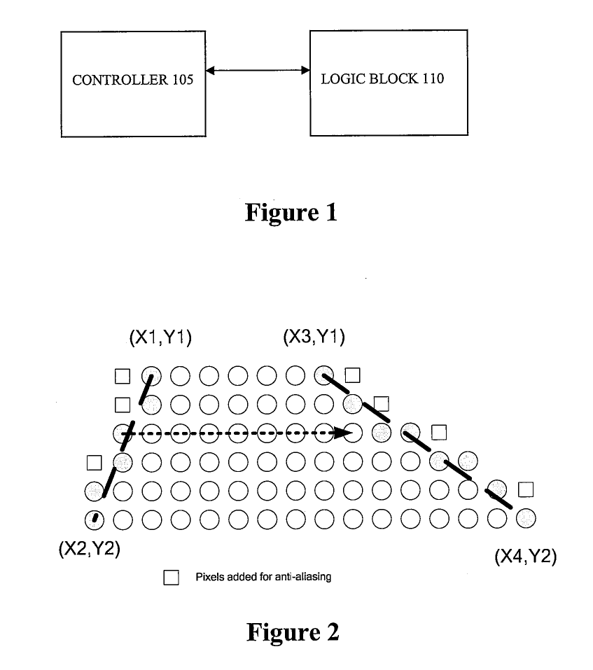

Referring now to FIG. 1, there is illustrated a block diagram describing an exemplary system for rendering graphical objects. The system comprises a controller 105 and a rendering logic block 110, both of which communicate with a system memory 115. The controller 105 can comprise, for example, a general purpose processor. In certain embodiments of the present invention, the controller 105 can comprise a MIPS processor.

In certain embodiments of the present invention, the controller 105 is dedicated to graphics tasks processes commands from a system or host processor (not shown), and decomposes graphics objects into primitives. In other embodiments the controller shares the graphics processing tasks with other system tasks. For graphics drawing, the controller 105 determines primitive decomposition. For some shapes (such as convex polygons, thick lines, rectangles), the shape is decomposed into a group of non-overlapping trapezoids. Other shapes (such as concave polygons, or ellipses), the controller 105 fills the shapes a scan line at a time. Font rendering can also be handled by the controller 105 (including outline scaling and grid fitting). The controller 105 passes the primitives to the logic block 110. The logic block 110 renders each primitive (scanline or trapezoid) sequentially by reading background pixel data from memory 115, generating the new pixels, blending them with the background and writing them back out to memory 115.

In certain embodiments of the present invention, the logic block 110 renders arbitrary trapezoids. The logic block 110 can render trapezoids with two horizontal and two non-horizontal sides. The logic block 110 can support anti-aliasing, filling with a solid color or repeated image tile, alpha-blending (‘alpha’ is a value that gives a degree of transparency to each pixel), and clipping.

In certain embodiments of the present invention, the logic block 110 supports different pixel formats such as true-color RGB+Alpha (32-bits/pixel), 8-bit greyscale, and 1-bit. The true-color outputs can be alpha pre-multiplied.

Referring now to FIG. 2, there is illustrated an exemplary trapezoid rendered in accordance with an embodiment of the present invention. In certain embodiments of the present invention, the trapezoid can include four points, wherein the top and bottom edges are horizontal, so X points and only two Y points can fully describe a trapezoid.

The pixels of the trapezoid can be written in a raster scan order. The logic block 110 can compute the left and right edges of a trapezoid using a standard Bresenham line-drawing algorithm. Extra pixels 205 are added if the edges are being anti-aliased. The fill area can be a solid color or an image tile pattern. The pattern can be the same format as the primitive (either RGBA or 8-bit greyscale), and will repeat in both the X and Y dimensions. The tile origin is specified along with the primitive's co-ordinates, so both drawing-surface anchored and object anchored tiles are supported.

The logic block 110 can break down the trapezoid into individual scans, processing each scan independently. First the scan endpoints are computed by iterating the Bresenham algorithm until the furthest points on the scan line are found. The endpoints can be extended, if necessary, to accommodate the extra pixels needed for anti-aliasing. The resulting endpoints produce a scan start and length, which are passed to pipeline blocks for data fetching, pixel creation and pixel writing.

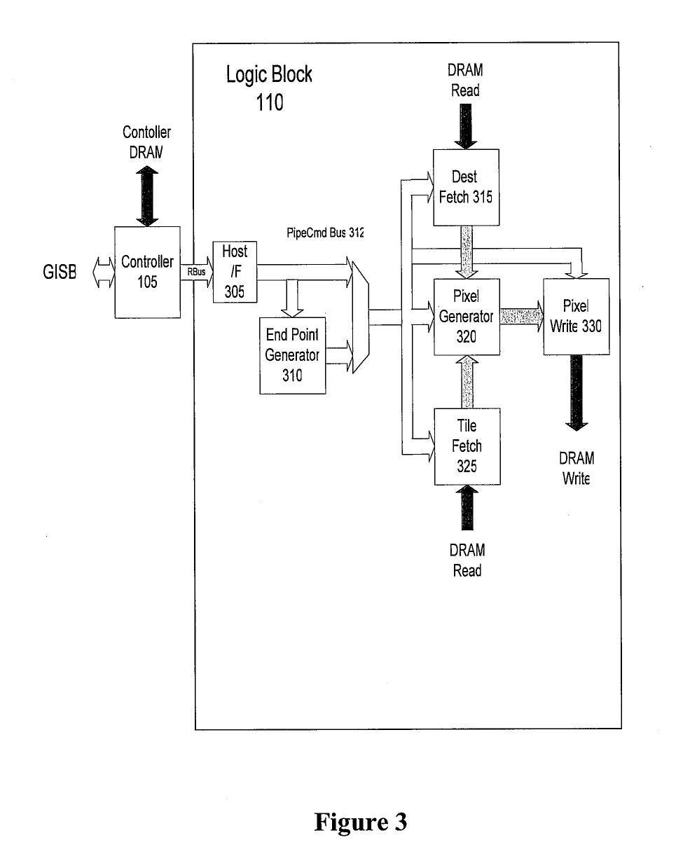

Referring now to FIG. 3, there is illustrated a block diagram of an exemplary logic block 110 in accordance with an embodiment of the present invention. The controller 105 segments graphics objects into trapezoid primitives. The controller 105 generates a series of register writes to the logic block 110 that specify the location and properties of the primitive. A FIFO in the host interface 305 stores the series of register writes and properties of the primitives. The host interface 305 passes the register writes out on a broadcast bus 312. In certain embodiments of the present invention, the broadcast bus 312 can be an address/data/strobe bus with no acknowledge that connects all the processing units (310, 315, 320, 325, 330). Each processing unit connects to the broadcast bus 312 with a filter and a command FIFO. The filter only passes register writes which are of interest to the processing block. These pass into the command FIFO, which allows the processing units to run in parallel.

When the host interface 305 broadcasts a command to initiate the drawing of a trapezoid (“DoTrapCmd”). This command is received by the End Point Generator 310, and the host cedes control of the broadcast bus 312 to the End Point Generator 310. Control returns to the host interface 305 once the end point generation for that trapezoid is complete.

The DoTrapCmd causes the End Point Generator block 310 to start mastering the bus. The End Point Generator 310 breaks a trapezoid into individual scan lines, and passes the scan line information (starting X position, length, etc) to the pixel manipulation blocks. This information is passed on the bus 312 as register writes in the same format as data coming from the host.

The destination fetch 315 and the tile fetch 325 blocks get pixel data from memory 115. The destination fetch 315 operates if the graphics primitive requires destination merging (merging of generated pixels with existing background pixels). The destination fetcher 315 buffers the data in a FIFO and supplies the pixels to the pixel generator 320, one pixel at a time.

The tile fetch 325 operates if the graphics primitive is being filled with a pattern rather than a solid color. The fill patterns are located in memory 115. The tile fetch 325 works in a similar manner to the destination fetch 315, except it “wraps around” when the end of the tile image scanline is reached. If the tile's width is small enough the entire scan is buffered and therefore only needs to be fetched once for a given scan. Otherwise the same tile may be fetched multiple times in a scan.

The pixel generator 320 computes a pixel value for each point in the scan. It takes either a solid fill color or tile pixels, computes an anti-alias value for it, merges it with destination pixels and finally does an alpha premultiply on the resulting value. The output pixel stream passes to a FIFO in the pixel writer, which collects up bursts for output and generates the output addresses.

A rectangular clipping region can be applied to primitives through register writes issued by the host interface 305. The End Point Generator 310 block does the vertical, y, clipping, by issuing dummy scan commands for the top clipped region and by stopping when the bottom clip region is reached. The End Point Generator 310 also cuts the length of scan commands to match the right clip. Left clipping is implemented by the Pixel Write block 330, which drops left-edge pixels until the edge of the clipping region is reached.

The EndptGen block converts the 2-dimensional trapezoid into a series of one-dimensional scans. It computes the left and right scan endpoints with the iterative Bresenham algorithm, and also computes an error distance to determine the number of extra anti-aliased pixels that are needed in the scan.

In certain embodiments of the present invention, the presence of a command FIFO in each block allows a number of steps to be performed in parallel. Because the register writes pass through these FIFOs it is possible for different blocks to be working in different scans or even different primitives simultaneously.

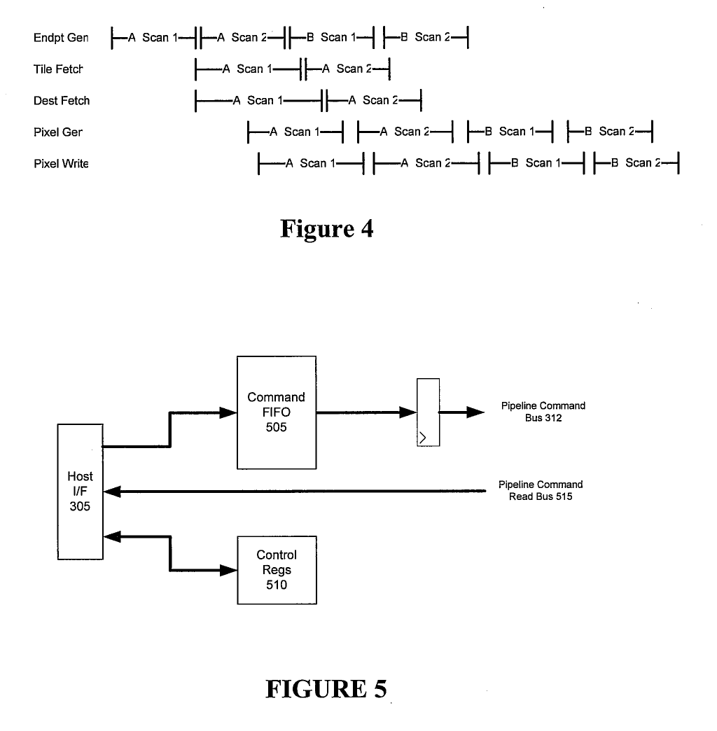

Referring now to FIG. 4, there is illustrated a diagram describing the operation of the rendering logic block 110 in accordance with an embodiment of the present invention. At time t0, the end point generator 310 starts operating on trapezoid A, scan line 1. At time t1, the end point generator 310 has completed the register writes for the first scanline, and it issues the “DoScanCmd” register write for that scanline. At time t2 end point generator 310 starts operating on trapezoid A, scan line 2, while the tile fetch block 325 and the destination fetcher 315 operate on trapezoid A, scan line 1. At time t3, pixel generator 320 starts operating on trapezoid A, scan line 1. At time t4, pixel write block 330 operates on trapezoid A, scan line 1. Each block will operate as long as pixel data is available at its inputs, and its output can accept data.

Referring now to FIG. 5, there is illustrated a block diagram of an exemplary host interface 305 and pipeline command bus 312 in accordance with an embodiment of the present invention. Access into the host interface 305 can be destined for the pipeline command bus 312 or for local control registers 510 as determined by address range checking. Pipeline command writes go to a command FIFO 505 and pipeline reads come from a pipeline command read bus 515.

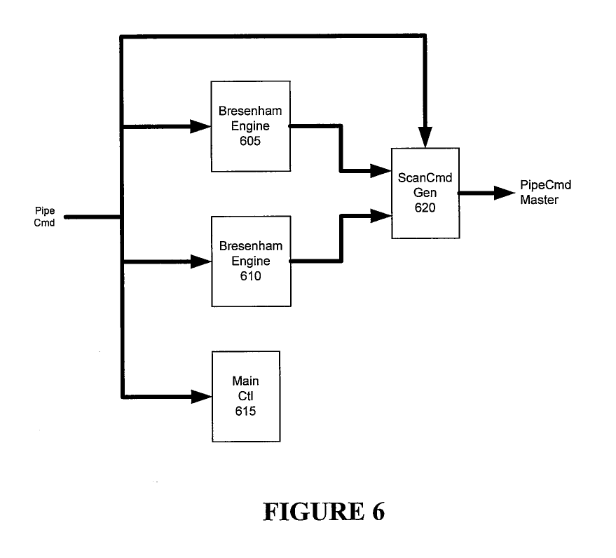

Referring now to FIG. 6, there is illustrated a block diagram describing an exemplary end point generator 310 in accordance with an embodiment of the present invention. The end point generator 310 comprises a pair of Bresenham engines 605, 610, a main controller 615, and a scan command generator 620.

A pair of Bresenham engines 605, 610 generate endpoints. One engine computes the left edge and the other computes the right. Each Bresenham engine 605, 610 determines a new X position for each Y scanline by updating a decision variable (bres_d).

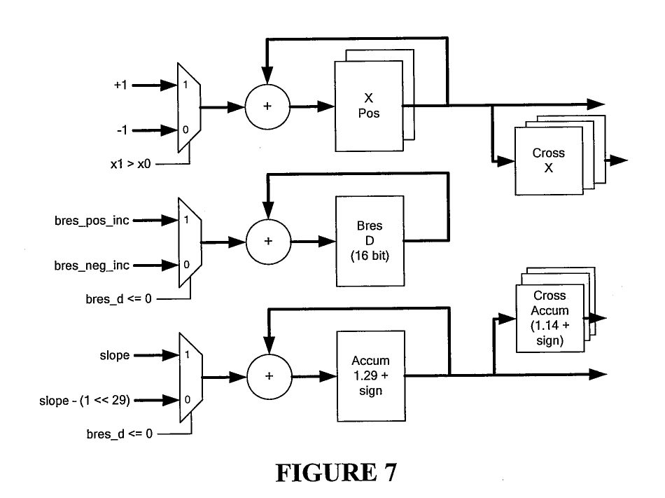

Referring now to FIG. 7, there is illustrated a block diagram of an exemplary Bresenham engine 605, 610 in accordance with an embodiment of the present invention. The Bresenham engine 605, 610 comprises an x position register, X Pos, a decision variable register, Bres D, an accumulator, Accum, a cross x register, Cross X, and a Cross Accumulation register, Cross Accum. For each scanline, these registers compute the endpoints of the scan, and the error value is used to generate the anti-aliased pixel values.

The registers are initialized at the start of a trapezoid endpoint operation from the X & Y position information.

Initialization:

XPos, XPos_d1, Cross_X, _d1, _d2 = X1 (left)

or X3 (right)

Dx = abs(X2 − X1) [left] or abs(X4 − X3)

[right]

Dy = Y2 − Y1
Bres_D = (dy > dx) ? ((dx << 1) − dy) : ((dy

<< 1) − dx)

Bres_pos_inc = ((dy > dx) ? dx : dy)

<< 1;

Bres_neg_inc = ((dy > dx) ? (dx − dy) : (dy −

dx)) << 1;

Accum, Cross_accum, _d1, _d2 = 0
X_end = X2 (left) or X4 (right)

In operation: The Bresenham engines 605, 610 get start pulses, which activates the Bresenham engines 605, 610 for some number of cycles, during which the bres_d and accum registers are updated, and the x_pos is conditionally updated. XPos_d1 holds the last value of XPos (enabled when Bres is active). It also gets loaded if XPos reaches X_end.

For steep slopes (dy>dx), the block runs for one clock and updates x_pos if bres_d>0, and updates Accum unconditionally.

For shallow slopes (dy<=dx), the block runs until bres_d is greater than 0, or until X reaches X_end. X_pos updates with every active clock, as does the accum register.

The ‘Cross’ registers are loaded at the start of a bres run, when the accumulator crosses from negative to positive (when dx>=dy), and at ‘go’ when dx<dy. They're also loaded when XPos reaches its end value (dx>=dy). The position and accumulator values are recorded at that point. These values are used to determine the ends of the anti-aliasing regions. There are 2 delayed copies of each (_d1, _d2). The delayed copies are initialized at the same time as the rest of the registers, but then they are loaded when the ‘Go’ is issued to the block (d2<=d1, d1 <=cross).

In certain embodiments of the present invention, a TileXPos register, which increments and decrements along with XPos, but does so modulo TileWidth. This supplies a starting tile position for each scanline. For example, the following pseudo code can be implemented:

If (update_pos) {
If (increment) TileXPos = (TileXPos == TileWidth

− 1) ? 0 : (TileXPos + 1)

Else TileXPos = (TileXPos == 0) ? (TileWidth − 1)

: (TileXPos − 1)

}

It is also captured in a ‘Cross’ register, at the same time as Cross_X. This output is set by the left edge generator.

The embodiments described herein may be implemented as a board level product, as a single chip, application specific integrated circuit (ASIC), or with varying levels of the system integrated with other portions of the system as separate components. The degree of integration of the system will primarily be determined by the speed and cost considerations. Because of the sophisticated nature of modern processors, it is possible to utilize a commercially available processor, which may be implemented external to an ASIC implementation. If the processor is available as an ASIC core or logic block, then the commercially available processor can be implemented as part of an ASIC device wherein certain functions can be implemented in firmware. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for rendering graphics, said system comprising:
a controller for decomposing graphics objects into primitives; and
logic for determining pixel locations for said graphics objects, using said primitives, wherein said logic block comprises an end point generator for generating end points for said graphics objects that are associated with scan lines.

2. The system of claim 1, wherein the controller further comprises a processor.

3. The system of claim 1, wherein said graphics objects comprise trapezoids.

4. The system of claim 1, wherein the end point generator generates the end points using a Bresenham algorithm.

5. The system of claim 4, wherein the end point generator further comprises
a first Bresenham engine for generating a first end point associated with each scan line; and
a second Bresenham engine for generating a second end point associated with each scan line.

6. The system of claim 1, wherein the logic block further comprises:
a tile fetcher for fetching a tile pattern; and
a pixel generator for generating pixels based at least one said tile pattern.

7. The system of claim 6, wherein the logic block further comprises:
a destination fetcher for fetching background pixels; and
wherein the pixel generator generates that pixels based at least on said tile pattern and said background pixels.

8. The system of claim 7, wherein the logic block further comprises:
a pipeline command bus for providing commands to the destination fetcher, the tile fetcher, and the pixel generator.

9. The system of claim 8, wherein the logic block further comprises a host interface for receiving primitives from the controller.

10. A circuit for rendering graphics, said circuit comprising:
a controller configured to decompose graphics objects into primitives; and
logic operatively coupled to said controller to determine pixel locations for said graphics objects, using said primitives, wherein said logic block comprises an end point generator configured to generate end points for said graphics objects that are associated with scan lines.

11. The circuit of claim 10, wherein the controller further comprises a processor.

12. The circuit of claim 10, wherein said graphics objects comprise trapezoids.

13. The circuit of claim 10, wherein the end point generator generates the end points using a Bresenham algorithm.

14. The circuit of claim 13, wherein the end point generator further comprises
a first Bresenham engine configured to generate a first end point associated with each scan line; and
a second Bresenham engine connected to the first Bresenham engine and configured to generate a second end point associated with each scan line.

15. The circuit of claim 10, wherein the logic block further comprises:
a tile fetcher configured to fetch a tile pattern; and
a pixel generator operatively coupled to the file fetcher to generate pixels based at least one said tile pattern.

16. The circuit of claim 15, wherein the logic block further comprises:
a destination fetcher configured to fetch background pixels; and
wherein the pixel generator is operatively coupled to the destination fetcher to generate pixels based at least on said tile pattern and said background pixels.

17. The circuit of claim 16, wherein the logic block further comprises:
a pipeline command bus operatively coupled to the to the destination fetcher, the tile fetcher, and the pixel generator to provide commands to the destination fetcher, the tile fetcher, and the pixel generator.
